(19) United States
(12) Patent Application Publication
(10) Pub. No.: US 2024/0086241 A1
(43) Pub. Date: Mar. 14, 2024

(54) ALGORITHM SELECTION FOR PROCESSOR-CONTROLLED DEVICE

(71) Applicant: BRITISH TELECOMMUNICATIONS PUBLIC LIMITED COMPANY, London (GB)

(72) Inventor: Ali SAJJAD, London (GB)

(21) Appl. No.: 18/555,149

(22) PCT Filed: Mar. 16, 2022
(86) PCT No.: PCT/EP2022/056828

§ 371 Date: Oct. 12, 2023

(30) Foreign Application Priority Data
Apr. 13, 2021 (GB) 2105235.2

(51) Int. Cl. G06F 9/50; G06F 11/30; G06F 11/34; H04L 9/14

(52) U.S. Cl. CPC G06F 9/5005; G06F 11/3024; G06F 11/3433; H04L 9/14

(57) ABSTRACT

A method of selecting an algorithm from a plurality of candidate algorithms for use by a processor-controlled device to perform an application. A respective value for one or more resource characteristics of the device is obtained. Based on the one or more values, one or more analogous reference devices having similar resource characteristics to the device are identified. One or more reference performance values for execution of each of the plurality of candidate algorithms on each of the analogous reference devices are obtained. The algorithm is selected based on the one or more reference performance values.

### TECHNICAL FIELD

The present invention relates to selection of an algorithm for a processor-controlled device.

### BACKGROUND

Various different algorithms may be executed by an electronic device to provide particular functionality. For example, there are a number of different cryptographic algorithms for encrypting and decrypting data. However, certain algorithms may be more suitable for use by a particular device than other algorithms.

It is known to identify an algorithm for use by a device for a given purpose by implementing and testing a number of different algorithms on the device and building a comparison table for the algorithms. The optimal algorithm for the device is then selected based on the comparison table.

However, this approach is not scalable. The number of tests to be performed increases dramatically as the number of devices to which an algorithm is to be deployed increases.

Furthermore, the tests generate a large amount of data, and therefore require a large amount of storage.

It is desirable to at least alleviate some of the aforementioned problems.

### SUMMARY

According to a first aspect of the present disclosure, there is provided a computer-implemented method of selecting an algorithm from a plurality of candidate algorithms for use by a processor-controlled device to perform an application, the method comprising: obtaining a respective value for one or more resource characteristics of the device; based on the one or more values, identifying one or more analogous reference devices having similar resource characteristics to the device; obtaining one or more reference performance values for execution of each of the plurality of candidate algorithms on each of the analogous reference devices; and selecting the algorithm based on the one or more reference performance values.

In some examples, the plurality of candidate algorithms are a plurality of candidate cryptographic algorithms.

In some examples, the one or more reference performance values comprise one or more resource loading values for the execution of each of the plurality of candidate algorithms on each of the analogous reference devices. The one or more resource loading values may be indicative of consumption of one or more hardware resources of the device for the execution of each of the plurality of candidate algorithms on each of the analogous reference devices. The one or more hardware resources may, for example, comprise: a processor of the device, storage of the device, or a power source of the device.

In some examples, the reference performance values comprise one or more algorithm performance values indicative of a performance of each of the plurality of candidate algorithms on each of the analogous reference devices.

In some examples, execution of each of the plurality of candidate algorithms comprises transmission of data via a network, and the reference performance values comprise a network characteristic value indicative of a data transmission characteristic associated with the transmission of the data via the network for the execution of each of the plurality of candidate algorithms on each of the analogous reference devices.

In some examples, the one or more resource characteristics comprise a respective characteristic of one or more hardware resources of the device, wherein optionally the one or more resource characteristics comprise one or more of: a processing capability of the device, a storage capability of the device, a power source of the device, or a communication capability of the device.

In some examples, identifying the one or more analogous reference devices comprises processing the one or more values for the one or more resource characteristics using a classifier trained to identify, from a plurality of reference devices, the one or more analogous reference devices having similar resource characteristics to the device.

In some examples, the method comprises obtaining one or more device performance values for execution of each of the plurality of candidate algorithms on the device, wherein selecting the algorithm comprises selecting the algorithm based further on the one or more device performance values. In some of these examples, obtaining the one or more device performance values comprises: executing each of the plurality of candidate algorithms on the device; and measuring the one or more device performance values for the execution of each of the plurality of candidate algorithms on the device. In some of these examples, the one or more device performance values comprise one or more device resource loading values for the execution of each of the plurality of candidate algorithms on the device.

In some examples, the method comprises obtaining a performance constraint to be satisfied by execution of the algorithm on the device, wherein selecting the algorithm comprises selecting the algorithm based further on the performance constraint. The performance constraint may comprise a resource loading constraint. In some of these examples, the plurality of candidate algorithms is a subset of available candidate algorithms and the method comprises selecting the plurality of candidate algorithms from the available candidate algorithms based on the performance constraint.

In some examples, the method comprises obtaining a score value for each of the plurality of candidate algorithms, based on the one or more reference performance values, wherein the algorithm is selected based on the score values.

In some examples, identifying the one or more analogous reference devices comprises identifying a plurality of analogous reference devices, and selecting the algorithm comprises selecting the algorithm based further on one or more of, for each of the reference performance values: an average performance value for each of the plurality of candidate algorithms, the average performance value for a respective candidate algorithm corresponding to an average of the reference performance value for execution of the respective candidate algorithm on each of the plurality of analogous reference devices; or a variance of the performance value for each of the plurality of candidate algorithms, the variance for a respective candidate algorithm corresponding to a variance of the reference performance value for execution of the respective candidate algorithm on each of the plurality of analogous reference devices.

In some examples, the one or more resource characteristics comprise a plurality of resource characteristics; the method comprises obtaining an importance metric for at least one of the plurality of resource characteristics indicative of a relative importance of the at least one of the plurality of resource characteristics in identifying the one or more analogous reference devices; and identifying the one or more analogous reference devices is based further on the importance metric for the least one of the plurality of resource characteristics.

In some examples, obtaining the one or more reference performance values comprises obtaining a plurality of reference performance values; the method comprises obtaining an importance metric for at least one of the plurality of reference performance values indicative of a relative importance of the at least one of the plurality of reference performance values in selecting the algorithm; and selecting the algorithm is based further on the importance metric for the least one of the plurality of reference performance values. In some of these examples, one or more of: the importance metric for the at least one of the plurality of resource characteristics or the importance metric for the least one of the plurality of reference performance values is received from a user.

In some examples, the method comprises instructing the device to use the algorithm to perform the application.

In some examples, the method is performed by a server of a network, the network further comprising the processor-controlled device.

According to a second aspect of the present disclosure, there is provided a data processing system configured to perform the method of any example in accordance with the first aspect.

According to a third aspect of the present disclosure, there is provided computer-readable medium storing thereon instructions which, when executed by a computer, cause the computer to carry out the method of any example in accordance with the first aspect.

### BRIEF DESCRIPTION OF THE DRAWINGS

For a better understanding of the present disclosure, reference will now be made by way of example only to the accompany drawings, in which:

FIG. 1 is a schematic diagram of a system according to an example;

FIG. 2 is a flow diagram of a method of selecting an algorithm according to an example;

FIG. 3 is a schematic diagram of a classifier system to identify one or more analogous reference devices according to an example;

FIG. 4 is a table of resource characteristics of reference devices according to an example;

FIGS. 5a and 5b are tables of reference performance values for two of the reference devices of FIG. 4;

FIG. 6 is a table of user-entered resource characteristics of a device for which an algorithm is to be selected according to an example;

FIG. 7 is a table of importance metrics of resource characteristics according to an example;

FIG. 8 is a table of importance metrics of reference performance values according to an example;

FIG. 9 is a table of detected resource characteristics of a device for which an algorithm is to be selected according to an example; and

FIG. 10 is a schematic diagram showing internal components of a data processing system according to an example.

### DETAILED DESCRIPTION

Apparatus and methods in accordance with the present disclosure are described herein with reference to particular examples. The invention is not, however, limited to such examples.

Examples herein relate to selection of an algorithm for use by a processor-controlled device to perform an application. The algorithm is selected from a plurality of candidate algorithms based on reference performance values for execution of the candidate algorithms on analogous reference devices that are identified as having similar resource characteristics to the device for which the algorithm is to be selected. In other words, a suitable algorithm can be selected for a particular device based on the performance of the algorithm on other devices that are similar to the device in question. This approach is scalable, and means that the performance of the candidate algorithms need not be re-evaluated for each new device for which an algorithm is to be selected. Instead, the algorithm can be selected for the new device based on the performance of the candidate algorithms on the analogous reference devices. This process is hence more efficient than existing approaches that involve testing each candidate algorithm on each new device for which an algorithm is to be selected. The amount of data generated and stored in examples herein may be lower than these existing approaches, especially where the method is to be applied repeatedly to select a suitable algorithm for a large number of different devices. For example, the reference performance values may be obtained for relatively few reference devices, and then re-used to select an appropriate algorithm for a large number of different devices by inferring the performance of the candidate algorithms on a particular device based on the reference performance values for those analogous reference devices that are similar to the particular device for which the algorithm is to be selected.

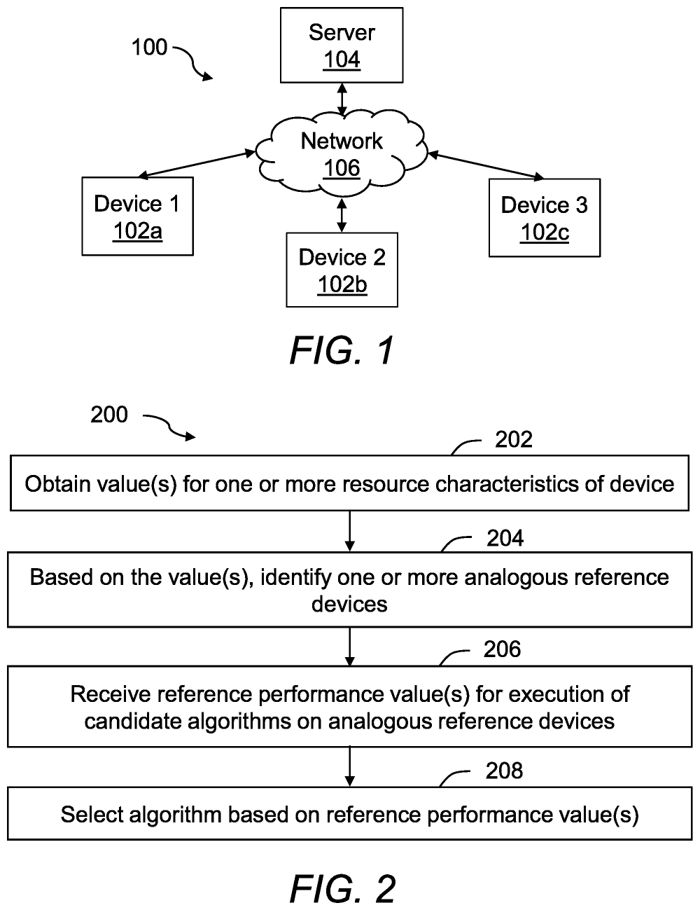

FIG. 1 is a schematic diagram showing an example of a system 100 including a plurality of devices 102a-102c and a server 104. The devices 102a-102c and the server 104 are each connected to a network 106, which is for example a telecommunications network. The network 106 may be a single network or may include a plurality of networks. The network 106 may be or include a wide area network (WAN), a local area network (LAN) and/or the Internet, and may be a personal or enterprise network.

The devices 102a-102c include a processor-controlled device 102a for which an algorithm is to be selected for use by the device 102a to perform an application. A processor-controlled device is for example any device controlled by a processor, such as a computer. In this example, the device 102a is an Internet of Things (IoT) device. An IoT device is for example a device with the means to communicate data within the environment, e.g. over a network local to the environment (such as the network 104 of FIG. 1). IoT devices can be included in the Internet of Things, which is a network of user devices such as home appliances, vehicles and other items embedded with electronics, software, sensors, actuators, and/or connectivity which enable these devices to connect with each other and/or other computer systems and exchange data. Examples of IoT devices include connected refrigerators, which can provide convenient online grocery shopping functionality, smart televisions (TVs), voice assistant devices, smart meters, environmental controllers (such as smart thermostats), and industrial IoT devices such as digital control systems for manufacturing, and sensors or environmental monitoring devices for various industrial applications such as agriculture or the maritime sector. IoT devices are typically resource-constrained and may therefore have relatively limited storage and/or processing capabilities. Certain algorithms may be unsuitable for use by a particular IoT device, such as the device 102a, for example if they require a storage and/or processing capability that exceeds that available at the device.

To address this, the server 104 of FIG. 1 is configured to select an algorithm for use by the device 102a to perform a particular application (such as a cryptographic algorithm for encryption and/or decryption). The server 104 selects the algorithm from a plurality of candidate algorithms using any of the example methods described herein. The server 104 then instructs the device 102a to use the selected algorithm to perform the application, for example by sending suitable instructions to the device 102a via the network 106. The device 102a then uses the algorithm to perform the application. A cryptographic algorithm may be used relatively frequently by the device 102a, e.g. for encryption of data for transmission to a remote device, such as the server 104, or decryption of data received from the remote device. Selection of an appropriate cryptographic algorithm for use by the device 102a can hence notably improve the performance of the device 102a and/or reduce resource consumption of the device 102a.

The server 104 may have greater computational resources than the device for which the algorithm is to be selected. In this case, use of the server 104 to perform the selection allows algorithms to be selected for devices that lack sufficient computational power to perform the selection process themselves. The server 104 can also select and deploy algorithms to a number of different devices, allowing the algorithm selection and deployment to be coordinated efficiently. This for example allows coordinated deployment of an updated algorithm or an algorithm to perform a particular application to a set of devices, such as a set of devices associated with a particular enterprise, e.g. to deploy the algorithm simultaneously to the set of devices.

FIG. 2 is a flow diagram of a method 200 of selecting an algorithm according to examples. The algorithm is selected from a plurality of candidate algorithms for use by a processor-controlled device (such as the device 102a of FIG. 1) to perform an application, for example to provide particular functionality for the device, e.g. to perform a particular task.

At item 202 of the method 200, a respective value for one or more resource characteristics of the device is obtained. A resource characteristic is for example a characteristic of a resource of or accessible to the device, such as a characteristic of a hardware resource of the device. The characteristic for example relates to a capability of the device to implement algorithms. For example, the one or more resource characteristics may include:
a processing capability of the device. The processing capability for example provides an indication of the available processing power of the device, and may be indicated by the clock speed of a processor accessible to the device and/or other characteristics of the processor such as the number of cores of the processor, the make and/or model of the processor and so forth.
a storage capability of the device. The storage capability for example indicates available storage system(s) of the device, such as whether the device includes certain types of storage, e.g. random access memory (RAM), external storage, and so forth. In some examples, the storage capability also or instead indicates the storage capacity of the storage systems of the device, such as the maximum amount of data that can be stored by each storage system.
a power source of the device, such as whether the device includes a battery. The resource characteristics may also include characteristics of the power source, such as the type of power source (e.g. the type of battery), and/or the output current that can be provided by the power source.
a communication capability of the device, such as whether the device is capable of communicating using a particular communication medium. For example, the communication capability may indicate whether the device is capable of communicating via WiFi and/or via Bluetooth and so forth. The communication capability may also indicate which particular protocol the device is configured to use if multiple protocols can be used to communicate via a particular medium (e.g. which particular Wi-Fi protocol or protocols the device is configured to use for wireless communication).

The values for the resource characteristics may be obtained in various different ways. In one example, a user of the device supplies the values, e.g. by entering the values using a suitable user interface. For example, the user can enter details of the device using an electronic form, e.g. an online form. In this case, the user can for example input a hardware specification (e.g. indicating details of the processor, storage, power source, communication capability etc. of the device), which may be taken as the resource characteristics or from which the values of the resources characteristics can be obtained. In another example, the values are detected by analysing the device. For example, a suitable monitoring process may be applied to the device to automatically detect the values, such as the /proc/cpuinfo routine, the top command, the ps (process status) command line utility, the vmstat command, or the nmon command on a Linux® operating system, or the Task Manager or SysInternals processes on a Windows® operating system.

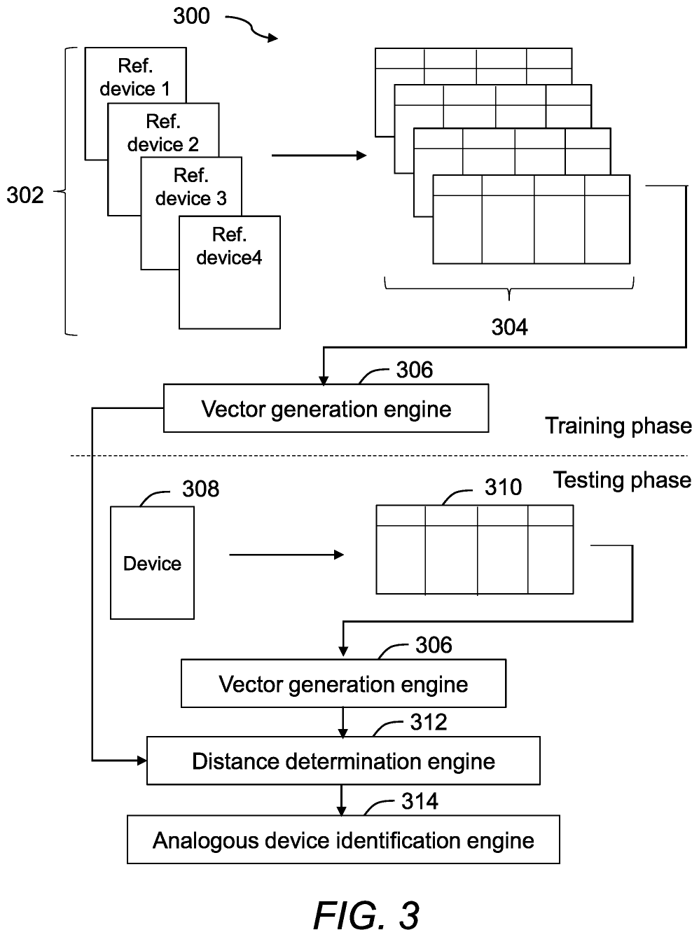

At item 204 of the method 200, one or more analogous reference devices having similar resource characteristics to the device are identified, based on the one or more values obtained at item 202. The analogous reference devices may be inferred from the resource characteristics of the device and resource characteristics of a plurality of reference devices, to identify those reference devices that have similar resource characteristics to the device. In one example, the values obtained at item 202 are processed using a classifier trained to identify, from a plurality of reference devices, the one or more analogous reference devices having similar resource characteristics to the device. An example such as this is shown in FIG. 3, which is discussed below. In other cases, though, the analogous reference devices may be identified in a different manner, e.g. based on a comparison between the resource characteristics of the device and the reference devices, or based on a comparison between a metric derived from the resource characteristics of the device and the reference devices.

At item 206 of the method 200, one or more reference performance values for execution of each of the plurality of candidate algorithms on each of the analogous reference devices are obtained. The reference performance values may include one or more resource loading values for the execution of each of the plurality of candidate algorithms on each of the analogous reference devices. A resource loading value for the execution of a particular candidate algorithm on a reference device for example represents or otherwise indicates the burden that running the candidate algorithm places on the reference device, e.g. the burden placed on resources of the reference device such as one or more hardware resources. For example, a resource loading value may be indicative of consumption of one or more hardware resources of the device, such as a processor, storage of the device, or a power source. Use of a resource loading value in selecting a suitable algorithm for a particular device hence allows the resource loading to be accounted for in the algorithm selection, e.g. to select an algorithm that does not unduly burden the device.

The one or more reference performance values may also or instead include one or more algorithm performance values indicative of a performance of each of the plurality of candidate algorithms on each of the analogous reference devices. In these cases, an algorithm performance value for execution of a particular candidate algorithm on a reference device for example indicates how well the candidate algorithm performs, such as how effectively and/or efficiently the candidate algorithm achieves a particular aim. For example, the number of cycles per byte (CPB), which indicates the number of clock cycles performed by a processor per byte of data processed in an algorithm, can be used as an algorithm performance value, e.g. for cryptographic algorithms. Using an algorithm performance value in the selection of an algorithm for a device allows an algorithm to be selected that provides a suitable level of performance. For example, the algorithm with the best performance can be selected, provided the algorithm is suitable for the device (e.g. provided that consumption of resources during execution of the algorithm does not exceed available resources on the device).

In some cases, execution of each of the plurality of candidate algorithms includes transmission of data via a network. This may be the case for example where the candidate algorithms are cryptographic algorithms, which involve the transfer of encrypted data. In these cases, the reference performance values may include a network characteristic value indicative of a data transmission characteristic associated with the transmission of the data via the network for the execution of each of the plurality of candidate algorithms on each of the analogous reference devices. A data transmission characteristic for example provides a measure of how efficiently the data can be transmitted via the network, and may indicate a rate at which the data can be transmitted or a time taken to transmit the data via the network. Example network characteristic values include a network latency and/or a network throughput. Accounting for the network characteristic value in the selection of the algorithm allows an algorithm to be selected that is appropriate for the available network resources, e.g. to avoid over-burdening the network.

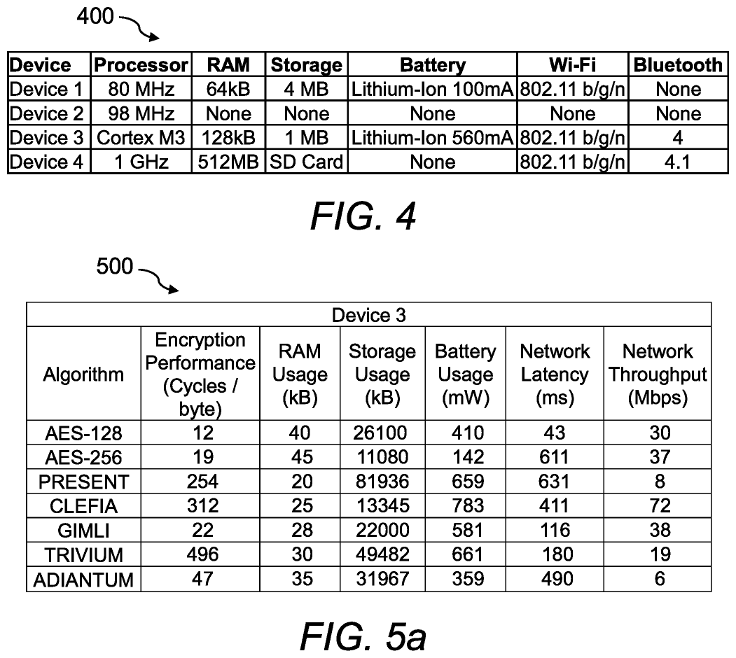

At item 208 of the method 200, the algorithm is selected based on the one or more reference performance values. The one or more reference performance values may be used in various ways to select the algorithm, as discussed further below with reference to FIGS. 4 to 9. For example, a score value may be obtained for each of the plurality of candidate algorithms, based on the one or more reference performance values. The score values may then be used to select which of the candidate algorithms to use as the algorithm on the device (although in other examples, the one or more reference performance values may be used separately to identify which algorithm is to be selected). As a further example, if there are a plurality of analogous reference devices, the algorithm may be selected based on an average performance value and/or a variance of the performance value for each reference performance value, for each of the candidate algorithms, so as to account for variations in the performance values between different reference devices for a particular candidate algorithm. For a particular reference performance value, an average performance value for a particular candidate algorithm for example corresponds to an average of that particular reference performance value for execution of the candidate algorithm on each of the plurality of analogous reference devices. For example, if there are three analogous reference devices and the reference performance values are P₁, P₂, P₃ for execution of a particular candidate algorithm on analogous reference devices 1, 2 and 3 respectively, the average performance value may be taken as an average of the values P₁, P₂, P₃, such as a mean of these values. Similarly, for a particular reference performance value, a variance for a particular candidate algorithm may be taken as a variance of that particular reference performance value for execution of the candidate algorithm on each of the plurality of analogous reference devices. In this same example, the variance may be taken as the variance of the values P₁, P₂, P₃. In some examples, the average performance value and/or the variance for each of the candidate algorithms, and for each of the reference performance values, is used to obtain the score value for that particular candidate algorithm. For example, if there are a plurality of reference performance values, a score may be obtained per reference performance value for a given candidate algorithm, and then each of the scores may be combined with each other (e.g. by performing a sum or a weighted sum of the scores) to obtain the score value for that particular candidate algorithm.

In some examples, one or more device performance values for execution of each of the plurality of candidate algorithms on the device is obtained. The device performance values are for example the same as the reference performance values, but for the device for which the algorithm is to be selected, rather than for a reference device. For example, the device performance values may include one or more device resource loading values for execution of each of the candidate algorithms on the device. The device resource loading values may be the same as the resource loading values described above for the reference devices, but for the device itself. The one or more device performance values may be used, in addition to the one or more reference performance values, to select the algorithm for the device. For example, the one or more device performance values may be used separately or may be combined with the one or more reference performance values (or with a measure or other metric derived from the reference performance values) to select the algorithm. In one case, a score value for each candidate algorithm is obtained using both the device and the reference performance values. Using the device performance values tends to increase the reliability of the process, meaning that a suitable algorithm is more likely to be selected than otherwise. However, in some cases, a suitable algorithm can be obtained without using the device performance values, which can increase the speed with which the algorithm is selected by omitting the procedure of obtaining the one or more device performance values.

If one or more device performance values is used, the device performance values may be obtained in various ways. For example, the device performance values for a particular candidate algorithm may be estimated based on the performance of similar algorithms on the device or may be obtained from a suitable data structure (such as a look-up table) based on execution of the candidate algorithm on a different device that has the same resource characteristics as the device (e.g. a device that is of the same make and model as the device for which the algorithm is to be selected). In one example, each of the plurality of candidate algorithms is executed on the device, and the one or more device performance values are measured for the execution of each of the candidate algorithms. This approach increases the accuracy of the device performance values obtained. In such cases, a performance value may be measured for each of a plurality of times an algorithm is executed on the device, and the obtained performance values may then be averaged to obtain a device performance value.

In some examples, the selection of the algorithm is based further on a performance constraint to be satisfied by execution of the algorithm on the device. The performance constraint for example indicates a particular requirement that must be met by the selected algorithm, e.g. such that the one or more device performance values meet particular criteria. In one example, the performance constraint is a resource loading constraint (although other constraints are possible, such as a network loading constraint). A resource loading constraint for example indicates that execution of the algorithm on the device must be associated with resource loading values that meet particular criteria, e.g. which meet or are less than a particular threshold value. This approach further refines the selection process, so as to select an algorithm that is suitable for the circumstances envisaged, so that the algorithm selected will not over-burden the device or a network to which the device is connected.

Similarly to the one or more resource characteristics for the device, the performance constraint can be obtained in various ways, e.g. from a user or using a monitoring process. In some cases, the performance constraint is derived from the one or more resource characteristics for the device. For example, if it is identified that the device has a particular amount of storage space available, this can be converted into a performance constraint, and used to identify candidate algorithms that utilise a lower amount of storage space than that available on the device.

In some examples, the candidate algorithms for which the one or more reference performance values are obtained are a subset of available candidate algorithms. In these examples, the candidate algorithms are selected from the available candidate algorithms based on the performance constraint. With this approach, candidate algorithms that are likely to be suitable for the device can be pre-selected, to reduce the number of candidate algorithms for which the reference performance values are obtained. This improves the efficiency of the selection process, by obviating the need to calculate or otherwise obtain reference performance values for candidate algorithms which are unlikely to be suitable for execution on the device. For example, if a particular candidate algorithm requires a large amount of processing power and/or storage, and the device for which the algorithm is to be selected is resource-constrained, with a smaller amount of processing power and/or storage than that needed to execute that particular candidate algorithm, that candidate algorithm is very unlikely to be suitable for use on the device. On that basis, that particular candidate algorithm can be excluded from the plurality of candidate algorithms for which the one or more reference performance values are obtained.

In some examples, the selection of the algorithm is based further on an importance metric for at least one of a plurality of reference performance values. The importance metric for a particular reference performance value for example indicates the relative importance of that reference performance value in selecting the algorithm. For example, the importance metric for a given reference performance value can be used as a weighting to weight a contribution of that reference performance value to a combined measure, such as the score value discussed above. With this approach, a greater importance (e.g. in the form of a greater weight) can be placed on a reference performance value that is considered to be more relevant in identifying a suitable algorithm for the device. This can improve the selection process, meaning that a suitable algorithm is more likely to be identified.

The importance metric for at least one of the reference performance values is received from a user in some cases, for example via a user interface. For example, a user can indicate an importance assigned to at least one of the reference performance values by entering a value in a suitable electronic form or by ranking the reference performance values as desired. This gives the user control over how the algorithm is selected, facilitating the selection of an algorithm in accordance with particular user preferences or priorities. For example, the user may be aware of other factors that may impact on the performance of a particular algorithm that are not directly accounted for in the reference performance values themselves, such as ongoing network usage by other devices or other processes on the device. The user can then appropriately assign an importance metric for at least one of the reference performance values to take account of these other factors. In other cases, though, the importance metric for at least one of the reference performance values may be obtained via a different process, e.g. by analysing subsequent performance of selected algorithms on various devices to identify an importance of respective reference performance values in selecting a suitable algorithm.

In some cases, an importance metric may also or instead be obtained for at least one of a plurality of resource characteristics of the device. Similarly to the importance metric for the at least one reference performance value, the importance metric for the at least one resource characteristic is for example indicative of a relative importance of the at least one resource characteristic in identifying one or more analogous reference devices that are similar to the device. In such cases, the importance metric for the at least one resource characteristic may for example be used to weight a contribution of respective resource characteristics to a combined measure for use in identifying the analogous reference devices. This is merely an example, though, and the importance metric for the at least one resource characteristic may be used in a different manner for identifying analogous reference devices (for example as described further below with reference to FIG. 3). Like the importance metric for the at least one reference performance value, the importance metric for the at least one resource characteristic may be obtained in various ways, such as from a user. It is to be appreciated that an importance metric need not be obtained for each reference performance value and/or each resource characteristic. For example, an importance metric may be obtained for a single reference performance value and/or resource characteristic, to indicate that that particular reference performance value and/or resource characteristic is of greater importance than the remaining reference performance values and/or resource characteristics.

FIG. 3 is a schematic diagram of a classifier system 300 to identify one or more analogous reference devices according to an example. The classifier in the example of FIG. 3 is a k-Nearest Neighbours classifier, however this is merely an example and other techniques, including other machine learning techniques, may be used to identify analogous reference devices in other examples.

In FIG. 3, the classifier system 300 is arranged to identify the one or more analogous reference devices from a plurality of reference devices 302 (four in this case, which are indicated schematically in FIG. 3). The reference devices 302 in this case have a variety of different resource characteristics, to increase the likelihood that at least one of the reference devices 302 will have similar resource characteristics to a given device for which an algorithm is to be selected. For example, if the method is to be applied in the context of IoT devices, the reference devices 302 may include a resource-constrained sensor (such as a binary-state change sensor, which is a low level sensor that registers a change in a state of a component using one of two values) and a relatively powerful IoT gateway device.

For each of the reference devices 302, a dataset 304 of resource characteristics is obtained. Hence, in the example of FIG. 3, four datasets 304 are obtained (and shown schematically in FIG. 3), with one dataset 304 per reference device 302. In this case, each dataset 304 corresponds to a device specification, which includes a set of characteristics of the resources of the corresponding reference device 302. The datasets 304 in this example are structured records each including a set of resource characteristic (name, value) pairs, which for example indicate the name of a particular resource of the reference device 302 and a value associated with the particular resource, such as (CPU, 100 MHz) to indicate that a reference device includes a central processing unit (CPU) with a master clock frequency of 100 megaHertz (MHz) or (Bluetooth, Yes) to indicate that a reference device can communicate via Bluetooth.

The classifier system 300 also includes a vector generation engine 306, which is configured to obtain a vector representation of the resource characteristics of each reference device 302, based on the dataset 304 for that reference device 302. The vector representation for a given reference device 302 provides a numerical representation of the resource characteristics of the reference device 302. The vector representations may be obtained in various ways. For example, each element of a vector may correspond to a value of a (name, value) pair of a corresponding dataset 304. In other examples, further processing may be applied to the values of a given dataset 304 to obtain a vector, e.g. using a vector embedding process to embed the values of the dataset 304 to a space of a particular dimension. The aspects of the classifier system 300 involving obtaining the datasets 304 and the vector representations for the reference devices 302 (using the vector generation engine 306) may be considered to correspond to a training phase.

After training the classifier system 300, a testing phase may then be performed to identify which of the reference devices 302 are similar to an input device 308 (such as a device for which an algorithm is to be selected). The testing phase of FIG. 3 involves obtaining a dataset 310 for the device 308, which in this case is the same as the datasets 304 for the reference devices 302 but for the device 308 rather than for the reference devices 302. A vector representation of the resource characteristics of the device 308 is then obtained based on the dataset 310 for the device 308 using the vector generation engine 306 (which in this example is the same as the vector generation engine for generating the vector representations of the reference devices 302, and applies the same method for generating the vector representations of the device 308 and the reference devices 302). The vector representations of the device 308 and the reference devices 302 are then processed by a distance determination engine 312, which is configured to determine a distance between the vector representation of the device 308 and each of the reference devices 302. In this case, the distance between two vectors indicates the similarity between the resource characteristics represented by the vectors: the distance between vector representations of a device and a reference device with similar resource characteristics will tend to be smaller than that of vector representations of a device and a reference device with dissimilar resource characteristics. Suitable distance metrics that may be determined as the distance include the Euclidean distance and the Hamming distance, although other distance metrics may be used in other examples.

In examples in which an importance metric is obtained for at least one resource characteristic, the importance metric or metrics may be used to weight the contribution of respective resource characteristics to the distance calculated by the vector generation engine 306. For example, the Euclidean distance, (x, x′), between a vector representation, x, of the device and a vector representation, x′, of a reference device may be calculated as:

d(x,x′)=\sqrt{(x₁−x′₁)²+ . . . +(xₙ−x′ₙ)²}

where xᵢ indicates the ith element of the vector representation of the device and x′ᵢ indicates the ith element of the vector representation of the reference device. In this case, each element of the vector representations corresponds to a different respective resource characteristic. In this case, the contribution of different resource characteristics to the calculated distance may be weighted by multiplying each term in the expression for the Euclidean distance by a corresponding weighting factor, wᵢ, to obtain the following expression for the Euclidean distance:

d(x,x′)=\sqrt{w₁(x₁−x′₁)²+ . . . +wₙ(xₙ−x′ₙ)²}

In this case, the weighting factor is derived from the importance metric. For example, the importance metric may be used as the weighting factor for a given resource characteristic, or the importance metric may be normalised and then used as the weighting factor for a given resource characteristic. However, this is merely an example.

The distances obtained by the distance determination engine 312 are processed by an analogous device identification engine 314, which is configured to identify one or more of the reference devices 302 as analogous reference devices with similar resource characteristics to the device 308. The analogous reference devices may be identified in various manners. For example, the reference devices 302 may be ranked from most to least similar based on the distances obtained by the distance determination engine 312 and the n most similar may be selected as the analogous reference devices (where n is an integer, which may e.g. be predetermined, such as a default value, or selected by a user). In another example, reference devices 302 with a distance that satisfies a particular condition, such as a distance that meets or is less than a threshold distance, are selected as analogous reference devices. With this approach, the number of analogous reference devices identified may differ for different devices 308 depending on how many of the reference devices 302 satisfy the condition. In this example, if no reference devices 302 satisfy the condition, the most similar reference device (or the n most similar reference devices) may be selected as the analogous reference device or devices, so that it is still possible to apply the subsequent steps of the algorithm selection method (although in this situation, the selected algorithm may be less suitable than otherwise, e.g. if even the most similar reference device has relatively different resource characteristics than the device for which the algorithm is selected). In this case, it may be identified that the set of reference devices 302 do not adequately represent the types of device for which an algorithm is to be selected. To address this, at least one additional reference device can be added to the set of reference devices 302, so as to include at least one reference device which is more similar to the device. It is to be appreciated that the vector generation engine 306, the distance determination engine 312 and/or the analogous device identification engine 314 may be implemented in software, hardware or a combination of software and hardware that is suitably programmed or otherwise configured.

An example of selection of an algorithm for a device will now be described with reference to FIGS. 4 to 9, to put the previous examples into context. FIG. 4 is a table 400 of resource characteristics of reference devices according to an example. In this example, there are four reference devices, and the resource characteristics are: the processor clock frequency, the available RAM, the available non-volatile storage (which may be integral to the device or external storage), the available battery, the capability of the device to communicate via Wi-Fi, and the capability of the device to communicate via Bluetooth. The values of the table 400 may be detected from the reference devices using a monitoring process or may be entered by a user.

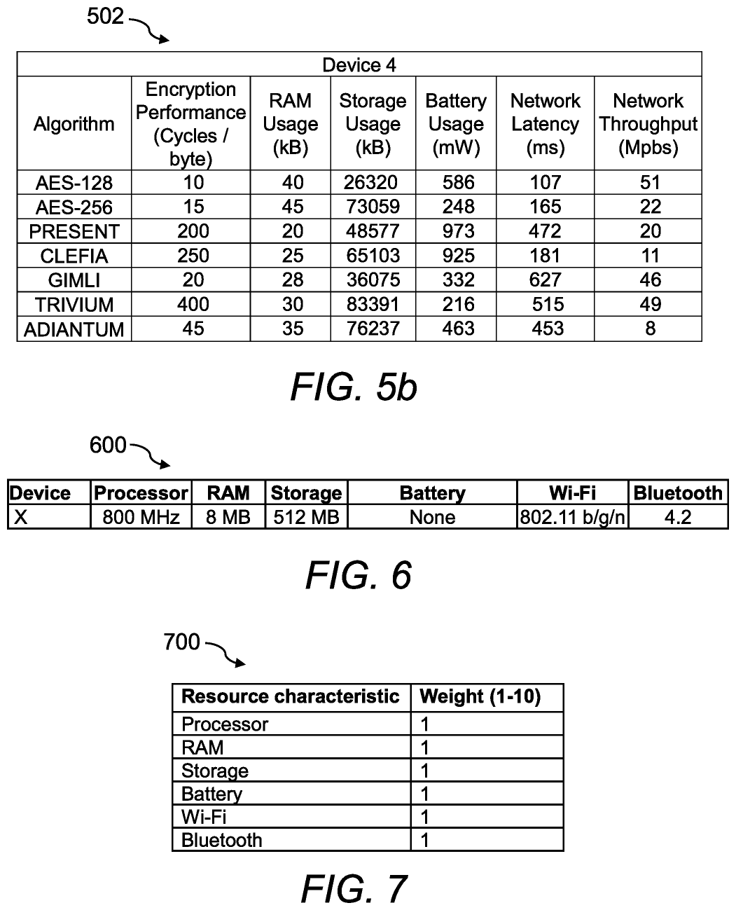

FIGS. 5a and 5b are tables 500, 502 of reference performance values for two of the reference devices of FIG. 4 (the third and fourth devices). However, although not shown, it is to be appreciated that similar reference performance value tables may be also obtained for the first and second devices of the table 400 of FIG. 4. The table 500 of FIG. 5a shows the reference performance values for reference device 3 of FIG. 4 and the table 502 of FIG. 5b shows the reference performance values for reference device 4 of FIG. 4. In FIGS. 5a and 5b, the reference performance values are obtained for the respective device for each of a plurality of candidate algorithms. There are seven candidate algorithms in FIGS. 5a and 5b, each of which are cryptographic algorithms: AES-128, AES-256, PRESENT, CLEFIA, GIMLI, TRIVIUM and ADIANTUM. The reference performance values for a particular candidate algorithm in this case are: the encryption performance (which is measured in cycles per byte, CPB), the RAM usage (which gives an indication of the RAM required to execute the candidate algorithm, in kilobytes (kB)), the storage usage (which gives an indication of the non-volatile storage required to execute the candidate algorithm, in kilobytes (kB)), the battery usage (which gives an indication of the battery power consumed to execute the candidate algorithm, in milliWatts (mW)), the network latency to execute the candidate algorithm (in milliseconds (ms)) and the network throughput (in megabytes per second (Mbps)). In this example, the reference performance values are obtained by executing each of the candidate algorithms on the respective device, and measuring the performance of each of the candidate algorithms. The tables 500, 502 may be considered to represent a performance profile for a given reference device.

FIG. 6 is a table 600 of user-entered resource characteristics of a device for which an algorithm is to be selected. In this example, the resource characteristics are the device type (which in this case is type X), the processor clock speed of the device (which in this case is 800 MHz), the size of the RAM of the device (which in this case is 8 MB), the size of the non-volatile storage of the device (which in this case is 512 MB), whether the device has a battery (which this device does not), the Wi-Fi capability of the device (which in this case indicates that the device is configured to communicate using the IEEE 802.11 b/g/n Wi-Fi protocol) and the Bluetooth capability of the device (which in this case indicates that the device is configured to communicate using the Bluetooth 4.2 specification). The resource characteristics may be considered to represent context of the device, which in this case indicates hardware specifications of the device. It is to be appreciated that, in other cases, the user may not have knowledge of the resource characteristics of the device. In such cases, the resource characteristics of a device may instead be obtained using a suitable monitoring process, e.g. as discussed further with reference to FIG. 9.

FIG. 7 is a table 700 of importance metrics of resource characteristics, which in this case correspond to the resource characteristics included in the table 600 of FIG. 6. The importance metrics of the resource characteristics indicate the relative importance of each of the resource characteristics in identifying a reference device with similar resource characteristics to those of the device with the resource characteristics shown in the table 600 of FIG. 6, and may be used to weight the resource characteristics in identifying the similar reference device as described further above. In this example, the importance metrics of the resource characteristics are in the form of a weight with a value from 1 to 10, with a lower value indicating a higher importance placed on a particular resource characteristic in identifying a similar reference device.

In the example table 700 of FIG. 7, each of the weights is 1, meaning that each of the resource characteristics are of equal importance in identifying a similar reference device. In other examples, though, one or more of the importance metrics of the resource characteristics may be greater than 1, and at least one of the importance metrics may differ from at least one other importance metric.

As noted above, the importance metrics of the resource characteristics may be entered by a user. In such cases, the user may enter the importance metrics of the resource characteristics when entering the resource characteristics themselves (e.g. via the same electronic form) or via a separate process. Entry of importance metrics of the resource characteristics is optional in some examples. In such examples, the table 700 of FIG. 7 (in which each resource characteristic is equally weighted) may represent default importance metrics of the resource characteristics which are used if the user does not choose to enter their own importance metrics. It is to be appreciated, though, that the weights in the table 700 are merely examples and, in other cases, at least one resource characteristic may have a different weight than another resource characteristic.

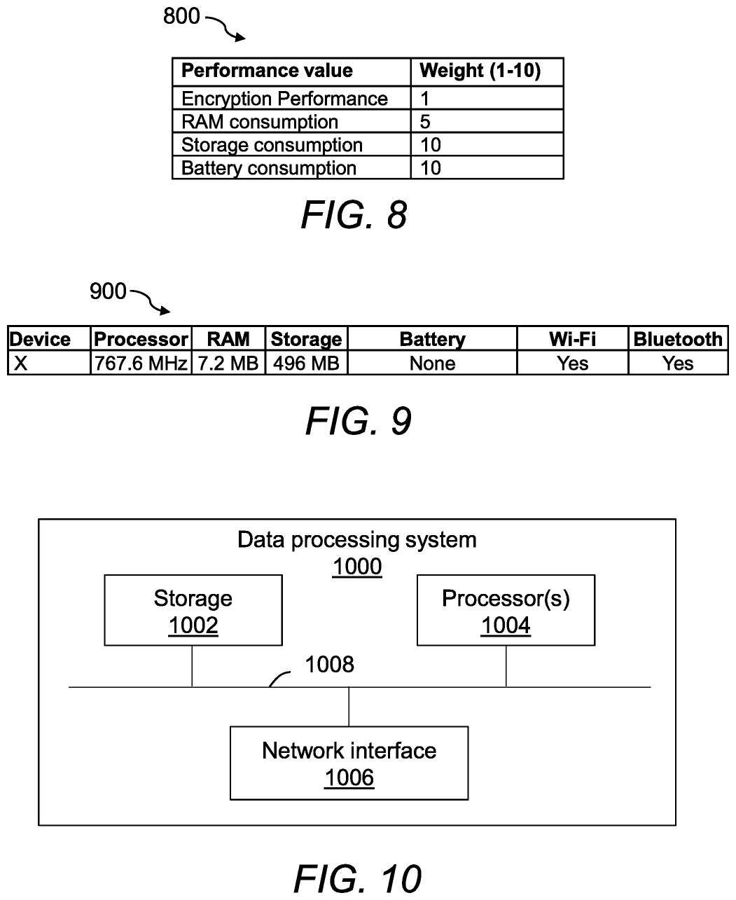

FIG. 8 is a table 800 of importance metrics of reference performance values, which in this case correspond to the reference performance values included in the tables 500, 502 of FIGS. 5a and 5b respectively. The importance metrics of the reference performance values indicate the relative importance of each of the reference performance values in selecting an algorithm for a device, and may be used to weight the reference performance values in selecting the algorithm, for example as described above. Similarly to the importance metrics of the resource characteristics, the importance metrics of the reference performance values may be user-selected and, in this case, take the form of a weight with a value from 1 to 10, with a lower value indicating a higher importance placed on a particular reference performance value in selecting a suitable algorithm. A lower value corresponding to a higher importance provides consistency with the reference performance values themselves, as typically lower reference performance values (e.g. lower number of cycles per byte, lower RAM consumption, lower storage capacity and/or lower network latency etc.) correspond to higher performance.

The example table 800 of FIG. 8 may be used to select a cryptographic algorithm for use by a device. In this example, the encryption performance has a weight of 1, the RAM consumption has a weight of 5 and the storage and battery consumptions each have a weight of 10. Use of these weights in the selection of the cryptographic algorithm allows the selection process to be weighted such that the encryption performance is of greatest importance (e.g. with the greatest contribution) in selecting the cryptographic algorithm, the RAM consumption is of lesser importance than the encryption performance but higher importance than the storage and battery consumptions, and the storage and battery consumptions are of least importance (e.g. with the lowest contribution) in selecting the cryptographic algorithm. In some cases, a default value may be used for each of the importance metrics unless values are received e.g. from a user. In such cases, the weight of each importance metric of the reference performance values may be the same as each other (so as to apportion equal importance to each of the reference performance values), or a default (e.g. predetermined) set of weights may be used for each of the reference performance values, in which case each weight need not necessarily be the same as each other weight.

FIG. 9 is a table 900 of detected resource characteristics of a device for which an algorithm is to be selected. The table 900 of FIG. 9 shows the resource characteristics for the same device as the table 600 of FIG. 6. However, whereas the resource characteristics in the table 600 of FIG. 6 were entered by a user, the resource characteristics in the table 900 of FIG. 9 were detected by a suitable monitoring or agent program on the device. User-entered resource characteristics (such as those of FIG. 6) for example represent the nominal resource characteristics, whereas detected resource characteristics (such as those of FIG. 9) for example represent the actual (e.g. measured) resource characteristics, which typically differ from the nominal values, and may be more accurate than the nominal values. Moreover, detected resource characteristics such as those of the table 900 of FIG. 9 may be obtained in situations in which no user-entered resource characteristics are available or have been received. In some cases, though, detected resource characteristics are used to confirm user-entered resource characteristics or vice versa.

A worked example will now be described with reference to the examples of FIGS. 4 to 9. In this example, it is desired to select a suitable cryptographic algorithm from the AES-128, AES-256, PRESENT, CLEFIA, GIMLI, TRIVIUM and ADIANTUM algorithms for device X. This example involves identifying one or more analogous reference devices from the reference devices of the table 400 of FIG. 4. In this case, it is desired to identify reference devices which, similarly to device X, can communicate via Bluetooth. As can be seen from FIG. 4 (which illustrates resource characteristics of reference devices), only devices 3 and 4 are configured to communicate via Bluetooth, so devices 3 and 4 are identified as the analogous reference devices. However, in other examples, further or alternative processing (such as the use of a classifier) may be used to identify analogous reference device(s) having similar resource characteristics to a device for which an algorithm is to be selected.

No performance metric is obtained for the resource characteristic in this case (as the analogous reference devices are identified on the basis of a single resource characteristic, which in this case is the capability to communicate via Bluetooth). However, as noted above, in other cases, at least one performance metric may be obtained for at least one of a plurality of resource characteristics, and used in identifying one or more analogous reference devices, such as the performance metrics shown in the table 700 of FIG. 7.

In this example, a performance constraint is also received (e.g. from a user or by measuring constraint(s) of the device itself). The performance constraint in this case is that the encryption performance must be less than or equal to 100 CPB and the RAM consumption must be less than or equal to 40 kB. FIGS. 5a and 5b show the reference performance values for devices 3 and 4, respectively. From the tables 500, 502 of FIGS. 5a and 5b, it can be seen that only three algorithms (AES-128, GIMLI and ADIANTUM) satisfy the performance constraint of an encryption performance of less than or equal to 100 CPB and a RAM consumption of less than or equal to 40 kB. The three algorithms that satisfy the performance constraint are taken as candidate algorithms from which the algorithm is to be selected, in this example.

Reference performance values for execution of the AES-128, GIMLI and ADIANTUM algorithms on each of devices 3 and 4 are obtained (e.g. from the tables 500, 502 of FIGS. 5a and 5b) and used to select which algorithm is to be used for the device X. In this case, two reference performance values are used: the encryption performance and the RAM consumption. A performance metric is also obtained for each of these reference performance values, which in this case is a weight with a value as shown in the table 800 of FIG. 8. However, other examples may use more or fewer reference performance values.

As explained above, there are various ways in which the reference performance values may be used to select an algorithm for use on a given device. For example, a score value may be obtained for execution of each of the candidate algorithms on each of the analogous reference devices based on a weighted function of a plurality of reference performance values.

In a first example, a score value, S, for a particular candidate algorithm is expressible as follows:

$$S = {\sum }_{i = 1}^{N} ( \frac{{μ}_{i}}{{μ}_{i} + {c}_{i}} \times {VC}_{i} \times {W}_{i} )$$

where: μᵢ is the average performance value of the ith reference performance value for execution of the candidate algorithm on each of the analogous reference devices; cᵢ is a performance constraint for the Rh reference performance value (e.g. obtained from a user); VCᵢ is the variance of the Rh reference performance value for execution of the candidate algorithm on each of the analogous reference devices; and Wᵢ is the importance metric for the Rh reference performance value (which in this case corresponds to the weight for the Rh reference performance value obtained from the table 800 of FIG. 8). In this case, the score value is calculated as a sum over N reference performance values.

As noted above, in this example the two reference performance values used to calculate the score value are the encryption performance and the RAM consumption. In this example, the score value for a particular candidate algorithm, according to the first example, can be expressed as:

$$S = ( \frac{{μ}_{e}}{{μ}_{e} + {c}_{e}} \times {VC}_{e} \times {W}_{e} ) + ( \frac{{μ}_{r}}{{μ}_{r} + {c}_{r}} \times {VC}_{r} \times {W}_{r} )$$

where: μₑ and μᵣ are, respectively, the average performance values of the encryption performance and the RAM consumption for execution of the candidate algorithm on each of the analogous reference devices; cₑ and cᵣ are, respectively, the performance constraints for the encryption performance and the RAM consumption; VCₑ and VCᵣ are, respectively, the variance of the encryption performance and the RAM consumption for execution of candidate algorithm on each of the analogous reference devices; and Wₑ and Wᵣ are, respectively, the importance metrics of the encryption performance and the RAM consumption.

In this example, cₑ=100 CPB and cᵣₐₘ=40 kB, as explained above.

$${VC}_{e} = \frac{{M}_{e}}{{STD}_{e}} ,$$

where

$${M}_{e} = \frac{12 + 10 + 22 + 20 + 47 + 45}{6} = 26 CPB$$

(which is the average encryption performance for execution of all of the candidate algorithms on devices 3 and 4, as can be seen from tables 500, 502 of FIGS. 5a and 5b respectively), and STDₑ=16.16 CPB (which is the standard deviation of the encryption performance for execution of all of the candidate algorithms on devices 3 and 4). This gives a value of VCₑ of 0.62. Wₑ is equal to 1, as taken from the table 800 of FIG. 8.

$${VC}_{r} = \frac{{M}_{r}}{{STD}_{r}} ,$$

where

$${M}_{r} = \frac{40 + 40 + 28 + 28 + 35 + 35}{6} = 34.33 KB$$

(which is the average RAM consumption for execution of all of the candidate algorithms on devices 3 and 4, as can be seen from tables 500, 502 of FIGS. 5a and 5b respectively), and STDₑ=5.39 kB (which is the standard deviation of the RAM consumption for execution of all of the candidate algorithms on devices 3 and 4). This gives a value of VCᵣ of 0.16. W, is equal to 5, as taken from the table 800 of FIG. 8. In this example, the average encryption performance and RAM consumption are the mean encryption performance and RAM consumption, respectively, but in other examples other averages than the mean may be used as the average of a particular performance value.

For execution of the AES-128 algorithm on device 3, the encryption performance is 12 CPB and the RAM consumption is 40 kB, and for execution of the AES-128 algorithm on device 4, the encryption performance is 10 CPB and the RAM consumption is 40 kB (see tables 500, 502 of FIGS. 5a and 5b). Hence, for the AES-128 algorithm, μₑ=(12+10)/2=11 CPB and μᵣ=(40+40)/2=40 kB. This gives a score value for the AES-128 algorithm of 0.45 according to the first example.

For execution of the GIMLI algorithm on device 3, the encryption performance is 22 CPB and the RAM consumption is 28 kB, and for execution of the GIMLI algorithm on device 4, the encryption performance is 20 CPB and the RAM consumption is 28 kB (see tables 500, 502 of FIGS. 5a and 5b). Hence, for the GIMLI algorithm, μₑ=(22+20)/2=21 CPB and μᵣ=(28+28)/2=28 kB. This gives a score for the GIMLI algorithm of 0.11 according to the first example.

For execution of the ADIANTUM algorithm on device 3, the encryption performance is 47 CPB and the RAM consumption is 35 kB, and for execution of the ADIANTUM algorithm on device 4, the encryption performance is 45 CPB and the RAM consumption is 35 kB (see tables 500, 502 of FIGS. 5a and 5b). Hence, for the ADIANTUM algorithm, μₑ=(47+45)/2=46 CPB and μᵣ=(35+35)/2=35 kB. This gives a score for the ADIANTUM algorithm of 0.20 according to the first example.

Using this first example method, the GIMLI algorithm has the lowest score and is selected for use by the device. For example, the algorithms may be ranked from highest to lowest score, with a lower score indicating greater suitability of a particular algorithm for use by the device, and the algorithm with the lowest score selected for use. In some cases, though, a ranked list of algorithms (e.g. ranked by score value) may instead be output and processed further to select an algorithm for use by the device. For example, the algorithm with the lowest rank may not be selected if the user does not have a suitable license to use the algorithm. In such cases, a different algorithm may instead be selected (e.g. the algorithm with the second-lowest rank, or the algorithm with the lowest rank that satisfies further criteria). Such further selection of the algorithm may be performed automatically (e.g. using a suitably configured further selection routine) or may be performed by a user.

This first example is merely one way in which the reference performance values may be used to select an algorithm for a device. In a second example, a score value, S, for a particular candidate algorithm is instead expressible as follows:

$$S = {\sum }_{i = 1}^{N} ( \frac{{v}_{i}}{{v}_{i} + {c}_{i}} \times {VC}_{i} \times {W}_{i} )$$

where cᵢ, VCᵢ and Wᵢ are as defined above, and vᵢ indicates a measured value of the ith device performance value for execution of the candidate algorithm on the device for which the algorithm is to be selected.

If the encryption performance and the RAM consumption are again used as the reference performance values, the score value for a particular candidate algorithm according to the second example can be expressed as:

$$S = ( \frac{{v}_{e}}{{v}_{e} + {c}_{e}} \times {VC}_{e} \times {W}_{e} ) + ( \frac{{v}_{r}}{{v}_{r} + {c}_{r}} \times {VC}_{r} \times {W}_{r} )$$

where: vₑ is the measured encryption performance of the candidate algorithm on the device; vᵣ is the measured RAM consumption of the candidate algorithm on the device; and cₑ, cᵣ, VCₑ, VCᵣ, Wₑ and Wᵣ are as defined above.

The values of cₑ, cᵣ, VCₑ, VCᵣ, Wₑ and Wᵣ are as given above for the first example. However, for execution of the AES-128 algorithm on the device, vₑ=14 CPB and vᵣ=35 kB. This gives a score value for the AES-128 algorithm of 0.076 according to the second example. For execution of the GIMLI algorithm on the device, vₑ=15 CPB and vᵣ=40 kB. This gives a score value for the GIMLI algorithm of 0.081 according to the second example. For execution of the ADIANTUM algorithm on the device, vₑ=11 CPB and vᵣ=30 kB. This gives a score value for the ADIANTUM algorithm of 0.062 according to the second example. Using this second example method, the ADIANTUM algorithm has the lowest score and is therefore selected for use by the device (although as explained above with reference to the first example, this need not be the case in all examples).

As can be seen, different approaches to calculating a score value for candidate algorithms can lead to different candidate algorithms being identified as most suitable for use on a particular device. In the examples above, the score values obtained according to the second example tend to be more accurate as it is based on device performance values for execution of candidate algorithms on the device, which are e.g. measured values. However, use of device performance values in selecting an algorithm (and hence, calculation of score values according to the second example) tends to be more resource-intensive and slower than other approaches that do not use such values (such as the method of the first example).

To address this, the values used in the selection of the algorithm for the device may themselves be selected based on various criteria such as a desired accuracy, resource usage, whether the device is accessible (e.g. whether a candidate algorithm can be executed on the device, which may not be possible if no physical or network access to the device is provided at the time the algorithm is to be selected), authorisation (e.g. whether a user or device is authorised to execute a candidate algorithm on the device), and/or desired level of interactivity or automation (e.g. whether the user wishes to enter values themselves or would prefer for values to be detected automatically), although this is not intended to be an exhaustive list. For example, if a desired accuracy is relatively high, a relatively high level of resource usage is acceptable, the device is accessible, authorisation has been provided for execution of candidate algorithms on the device and/or automation is allowed, the algorithm may be selected based on one or more device performance values, e.g. according to the second example. If otherwise, though, or if it is otherwise not possible to obtain device performance values, the algorithm may be selected without use of device performance values, e.g. according to the first example.

FIG. 10 is a schematic diagram of internal components of a data processing system 1000 that may be used in any of the methods described herein. The data processing system 1000 may include additional components not shown in FIG. 10; only those most relevant to the present disclosure are shown. The data processing system 1000 may be or form part of a device for which an algorithm is to be selected, a reference device, or a computer system for use in selecting the algorithm (e.g. a server system). The data processing system 1000 in FIG. 10 is implemented as a single computer device but in other cases an otherwise similar data processing system may be implemented as a distributed system.

The data processing system 1000 includes storage 1002 which may be or include volatile or non-volatile memory, read-only memory (ROM), or random access memory (RAM). The storage 1002 may additionally or alternatively include a storage device, which may be removable from or integrated within the data processing system 1000. For example, the storage 1002 may include a hard disk drive (which may be an external hard disk drive such as a solid state disk) or a flash drive. The storage 1002 is arranged to store data, temporarily or indefinitely. For example, if the data processing system 1000 is used to select an algorithm for use by a device according to the examples herein, the storage 1002 may for example store a respective value for one or more resource characteristics of the device, a respective value for one or more resource characteristics of at least one reference device, one or more performance values for execution of one or more candidate algorithms on each of one or more analogous reference devices, one or more device performance values, a performance constraint to be satisfied by execution of the algorithm on the device, and/or various values generated, e.g. based on the one or more performance values and/or the one or more device performance values, for use in the selection of the algorithm, such as score values for respective candidate algorithms. The storage 1002 may be referred to as memory, which is to be understood to refer to a single memory or multiple memories operably connected to one another.

The storage 1002 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

The data processing system 1000 also includes at least one processor 1004 which is configured for use in implementing any of the methods herein. The at least one processor 1004 may be or comprise processor circuitry. The at least one processor 1004 is arranged to execute program instructions and process data. The at least one processor 1004 may include a plurality of processing units operably connected to one another, including but not limited to a central processing unit (CPU) and/or a graphics processing unit (GPU).

The data processing system 1000 further includes a network interface 1006 for connecting to at least one network, e.g. to receive data such as that which may then be stored in the storage 1002 and/or to communicate with another data processing system via a network. For example, the data processing system 1000 may select an algorithm for use by a device and then send a command, via the network interface 1006, to instruct the device to implement the algorithm. The components of the data processing system 1000 are communicably coupled via a suitable bus 1008.

Further examples are envisaged. Examples above describe the selection of an algorithm for an IoT device. However, it is to be appreciated that any of the methods and systems described herein may be used to select an algorithm for a different type of processor-controlled device, e.g. so as to select an algorithm that makes efficient use of the resources of the device and/or that achieves a particular performance level. Moreover, although examples above describe the selection of a cryptographic algorithm, it is to be appreciated that the methods herein may be used to select other types of algorithm than cryptographic algorithms.

In FIG. 1, a server 104 selects an algorithm for a device 102a. However, in other examples, the algorithm is selecting by a different component, such as the device itself or by a further computer device.

Further examples relate to a computer-readable medium storing thereon instructions which, when executed by a computer, cause the computer to carry out the method of any of the examples described herein.

Each feature disclosed herein, and (where appropriate) as part of the claims and drawings may be provided independently or in any appropriate combination. Any apparatus feature may also be provided as a corresponding step of a method, and vice versa.

In general, it is noted herein that while the above describes examples, there are several variations and modifications which may be made to the described examples without departing from the scope of the appended claims. One skilled in the art will recognise modifications to the described examples.

Any reference numerals appearing in the claims are for illustration only and shall not limit the scope of the claims. As used throughout, the word ‘or’ can be interpreted in the exclusive and/or inclusive sense, unless otherwise specified.

1. A computer-implemented method of selecting an algorithm from a plurality of candidate algorithms for use by a processor-controlled device to perform an application, the method comprising:
obtaining a respective value for one or more resource characteristics of the device;
based on the one or more values, identifying one or more analogous reference devices having similar resource characteristics to the device;
obtaining one or more reference performance values for execution of each of the plurality of candidate algorithms on each of the analogous reference devices; and
selecting the algorithm based on the one or more reference performance values.

2. The method of claim 1, wherein the plurality of candidate algorithms are a plurality of candidate cryptographic algorithms.

3. The method of claim 1, wherein the one or more reference performance values comprise one or more resource loading values for the execution of each of the plurality of candidate algorithms on each of the analogous reference devices.

4. The method of claim 3, wherein the one or more resource loading values are indicative of consumption of one or more hardware resources of the device for the execution of each of the plurality of candidate algorithms on each of the analogous reference devices, wherein optionally the one or more hardware resources comprise: a processor of the device, storage of the device, or a power source of the device.

5. The method of claim 1, wherein the reference performance values comprise one or more algorithm performance values indicative of a performance of each of the plurality of candidate algorithms on each of the analogous reference devices.

6. The method of claim 1, wherein execution of each of the plurality of candidate algorithms comprises transmission of data via a network, and the reference performance values comprise a network characteristic value indicative of a data transmission characteristic associated with the transmission of the data via the network for the execution of each of the plurality of candidate algorithms on each of the analogous reference devices.

7. The method of claim 1, wherein the one or more resource characteristics comprise a respective characteristic of one or more hardware resources of the device, wherein optionally the one or more resource characteristics comprise one or more of: a processing capability of the device, a storage capability of the device, a power source of the device, or a communication capability of the device.

8. The method of claim 1, wherein identifying the one or more analogous reference devices comprises processing the one or more values for the one or more resource characteristics using a classifier trained to identify, from a plurality of reference devices, the one or more analogous reference devices having similar resource characteristics to the device.

9. The method of claim 1, comprising obtaining one or more device performance values for execution of each of the plurality of candidate algorithms on the device, wherein selecting the algorithm comprises selecting the algorithm based further on the one or more device performance values.

10. The method of claim 9, wherein obtaining the one or more device performance values comprises:
executing each of the plurality of candidate algorithms on the device; and
measuring the one or more device performance values for the execution of each of the plurality of candidate algorithms on the device.

11. The method of claim 9, wherein the one or more device performance values comprise one or more device resource loading values for the execution of each of the plurality of candidate algorithms on the device.

12. The method of claim 1, comprising obtaining a performance constraint to be satisfied by execution of the algorithm on the device, wherein selecting the algorithm comprises selecting the algorithm based further on the performance constraint.

13. The method of claim 12, wherein the performance constraint comprises a resource loading constraint.

14. The method of claim 12, wherein the plurality of candidate algorithms is a subset of available candidate algorithms and the method comprises selecting the plurality of candidate algorithms from the available candidate algorithms based on the performance constraint.

15. The method of claim 1, comprising obtaining a score value for each of the plurality of candidate algorithms, based on the one or more reference performance values, wherein the algorithm is selected based on the score values.

16. The method of claim 1, wherein identifying the one or more analogous reference devices comprises identifying a plurality of analogous reference devices, and selecting the algorithm comprises selecting the algorithm based further on one or more of, for each of the reference performance values:
an average performance value for each of the plurality of candidate algorithms, the average performance value for a respective candidate algorithm corresponding to an average of the reference performance value for execution of the respective candidate algorithm on each of the plurality of analogous reference devices; or
a variance of the performance value for each of the plurality of candidate algorithms, the variance for a respective candidate algorithm corresponding to a variance of the reference performance value for execution of the respective candidate algorithm on each of the plurality of analogous reference devices.

17. The method of claim 1, wherein:
the one or more resource characteristics comprise a plurality of resource characteristics;
the method comprises obtaining an importance metric for at least one of the plurality of resource characteristics indicative of a relative importance of the at least one of the plurality of resource characteristics in identifying the one or more analogous reference devices; and
identifying the one or more analogous reference devices is based further on the importance metric for the least one of the plurality of resource characteristics.

18. The method of claim 1, wherein:
obtaining the one or more reference performance values comprises obtaining a plurality of reference performance values;
the method comprises obtaining an importance metric for at least one of the plurality of reference performance values indicative of a relative importance of the at least one of the plurality of reference performance values in selecting the algorithm; and
selecting the algorithm is based further on the importance metric for the least one of the plurality of reference performance values.

19. The method of claim 17, wherein one or more of: the importance metric for the at least one of the plurality of resource characteristics or the importance metric for the least one of the plurality of reference performance values is received from a user.

20. The method of claim 1, comprising instructing the device to use the algorithm to perform the application.

21. The method of claim 1, performed by a server of a network, the network further comprising the processor-controlled device.

22. A data processing system configured to perform the method of claim 1.

23. A computer-readable medium storing thereon instructions which, when executed by a computer, cause the computer to carry out the method of claim 1.
